(19) United States
(12) Patent Application Publication
(10) Pub. No.: US 2008/0033791 A1
(43) Pub. Date: Feb. 7, 2008

(54) Method and system tracking work done by human workers

(75) Inventors: Scott A. Jones, Carmel, IN (US); Thomas E. Cooper, Carmel, IN (US)

Correspondence Address: STAAS & HALSEY LLP, SUITE 700, 1201 NEW YORK AVENUE, N.W., WASHINGTON, DC, 20005, US

(73) Assignee: CHACHA SEARCH, INC, Carmel, IN (US)

(21) Appl. No.: 11/652,506

(22) Filed: Jan. 12, 2007

Related U.S. Application Data
(60) Provisional application No. 60/807,683, filed on Jul. 18, 2006.

(51) Int. Cl. G06F 11/34

(52) U.S. Cl. 705/11

(57) ABSTRACT

A system and method for tracking work performed by a human worker and providing a graphic representation for gauging points, cash, credits, compensation, or other recognition earned by the human worker in association with the work. In the case of a human-assisted search engine, a sponsoring searcher or worker may sign up other searchers or workers and make a percentage of the compensation earned by the signed-up searchers.

### CROSS-REFERENCE TO RELATED APPLICATIONS

This application is related to and claims the benefit of U.S. Application Ser. No. 60/807,683, filed Jul. 18, 2006, inventor Scott A. Jones, et al., titled METHOD AND SYSTEM TRACKING WORK DONE BY HUMAN WORKERS, in the United States Patent and Trademark Office, the disclosures of which is incorporated herein by reference.

### BACKGROUND

1. Field

The present invention is directed to tracking progress of work and, more particularly, to identifying goal(s) for human worker(s), tracking work performed by the worker(s), tracking work performed by others and tracking and reporting progress with respect to the identified goal(s).

2. Description of the Related Art

Various types of technologies have been developed for assisting users in monitoring tasks performed by the users. Typical task management technologies maintain information pertaining to the task such as users performing the task, order of completion, estimated date of completion, task deadlines, resources associated with the task, duration of the task including dependencies of sub-tasks, etc., and indicate progress towards completion of the task based on the users' performance of the task. However, current task management technologies are generally limited to multi-user monitoring and do not provide individualized tracking of task(s) specific to each user participating in performing the task, or focus on monitoring tasks of a single user who is solely responsible for completion of a task.

Typical task management technologies are designed to monitor progress of a task with respect to an overall objective set for the task such as a completion date, a desired end product, etc., regardless of the number of users involved in performing the task. Specifically, the task management technologies do not monitor individualized objectives corresponding to each individual user to reflect progress of each user towards the objectives in accordance with performance of a respective role by each user for completing the task. For example, a single user performing sub-task(s) towards achieving the overall objective of the task shared by the group of users is unable to set specific objectives that may be motivating the user and is not provided with progress information pertaining to those objectives. Instead, each user is limited to collaborative progress information pertaining to the overall objective shared by all users.

Although progress information provided by the task management technologies may be deciphered to obtain data pertaining to a particular user, the information provided by such task management technologies is generally designed with the assumption that only one of the users will modify data supplied for managing the task and is generally not customizable by each individual user.

The need for a flexible tool for monitoring a task performed by users becomes especially important when the structure of the task involves crediting users for sub-tasks or tasks performed by others in cases such as that of a multi-level marketing system. Inability of typical task management technologies to individualize task progress information provided to users of a multi-level marketing system poses additional problems in a multi-level marketing design implemented with several layers.

Although various task scheduling and monitoring tools are known, there is a need for a method and system for tracking work performed by human worker(s) in accordance with identified goal(s) of each individual worker and displaying corresponding information in accordance with the tracking.

### SUMMARY

A system and method are disclosed for tracking work progress towards achieving a goal identified by an individual human worker and for providing customized information including a breakdown of exactly how work to achieve the goal is being accomplished, number of work hours, resources used, etc.

The method and system disclosed include associating a selected goal of a human worker with work performed by the human worker and tracking work performed towards the selected goal.

The disclosed method includes selecting a goal related to work of human worker(s), where the selected goal pertains to each human worker, individually tracking of work associated with each worker in association with the selected goal, including work which may be performed by others on behalf of a worker and correspondingly displaying the tracked work with respect to the goal.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is a block diagram of a system for tracking work done by human worker(s).

FIG. 2 is a flowchart for tracking progress of work with respect to goal(s) selected by a worker.

FIG. 2A is a flowchart for tracking work performed by a worker and workers sponsored by the worker with respect to a goal.

FIG. 3 is a table of information on workers maintained by a system.

FIG. 4, 4A and 4B are graphical user interfaces (GUIs) for displaying information pertaining to work or task(s) associated with a worker.

FIG. 5 is a GUI for displaying information of work or task(s) performed by worker(s) sponsored by an individual worker.

FIG. 6 is a flowchart for displaying credit(s) awarded to a worker in association with goal(s) specific to the worker.

FIG. 7 is a relationship diagram illustrating tracking of work performed by guide(s).

### DETAILED DESCRIPTION OF THE PREFERRED EMBODIMENTS

Reference will now be made in detail to the present embodiments discussed herein, examples of which are illustrated in the accompanying drawings, wherein like reference numerals refer to the like elements throughout. The embodiments are described below to explain the disclosed system and method by referring to the figures. It will nevertheless be understood that no limitation of the scope is thereby intended, such alterations and further modifications in the illustrated device, and such further applications of the principles as illustrated therein being contemplated as would normally occur to one skilled in the art to which the embodiments relate.

The disclosed method and system include tracking work done by human workers. In the examples described below, the worker is described as a human provider (or variously known as a Guide, PaidSearcher™, or worker), a person who has registered to handle requests (e.g., search requests) from requesters (or variously known as users, InfoSeekers™ or information seekers) who may be a professional, an amateur and/or volunteer. For example, a worker may be a searcher as discussed in U.S. patent application Ser. No. 11/336,928, filed Jan. 23, 2006, the disclosure of which is incorporated herein by reference. However, the present invention is not limited to this example and can be used to track work performed in other situations. For example, the disclosed system and method may be used to track various types of works including the types of work available through the Amazon® Mechanical Turk service.

In the examples below, a requester (InfoSeeker™) is a user submitting a request to seek information or to present work to be performed by human worker(s) for the user or on behalf of another person or organization. An information source is a system, an application program, or any other source from which data pertaining to goal(s) or request(s) submitted by a human worker may be obtained and may include text, image(s), multimedia, or any other electronic information. A goal is an intended outcome identified by a worker in relation to work performed by the worker such as a cash amount, an actual product, a trip to a favorite destination, etc. A credit is any type of recognition earned by a worker on behalf of the worker or other workers for performing work including cash, points, etc. A request is a submission by a requester requesting completion of work by human workers(s) such as a search, photograph identification, transcription of audio recordings, image matching, etc.

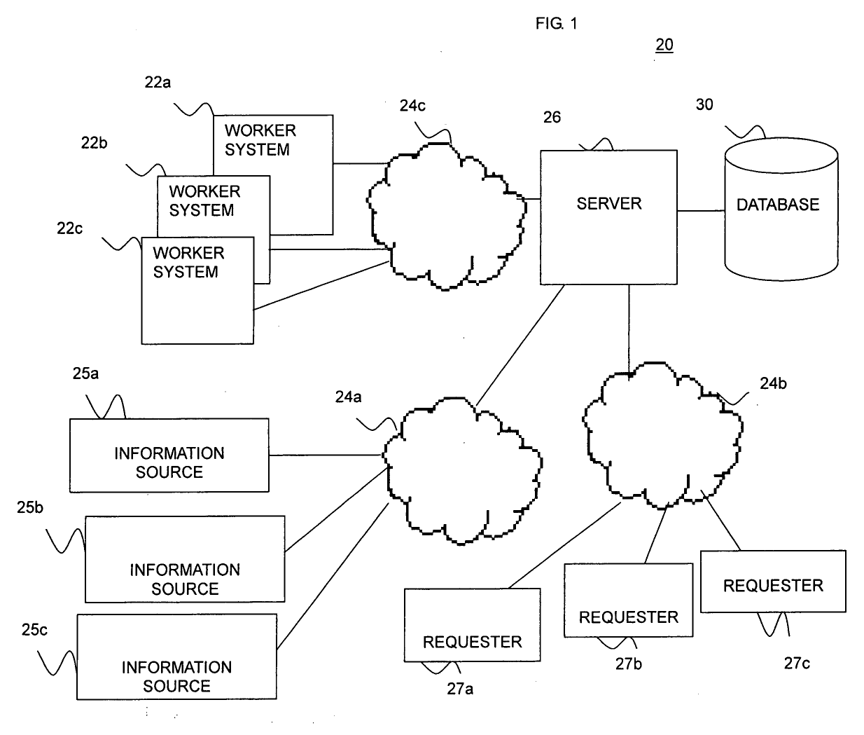

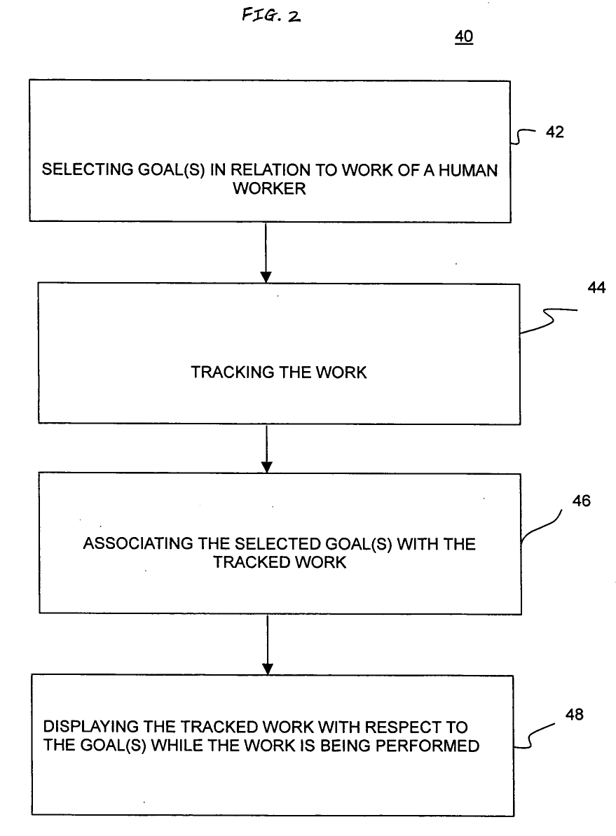

FIG. 1 illustrates an exemplary system 20 for tracking work performed by human worker(s). The system 20 includes a server 26 managing requests submitted by requesters 27 via network 24b and results of work performed by worker(s) utilizing at least one of worker systems 22 in response to the requests. The requesters 27 may use any text- or speech-based device for submitting a request via the network 24b and the request may be submitted to the worker systems 22 via network 24 to enable the human worker(s) to respond to the request, or the request may be processed by the server 26 to return results to the requesters 27 based on stored information in database 30.

The worker systems 22 are connected to the server 26 via network 24c and are used by human workers who have registered with the system 20 for handling requests from the requesters 27. Similar to the devices used by the requesters 27, the worker systems 22 utilized by the workers may be any text- or speech-based systems such as a desktop or laptop computer, a handheld device such as a personal digital assistant (PDA), a cellular telephone, or any other device that allows a worker to receive and respond to a request from the requesters 27 via text or speech entry. When a worker registers with the system 20, the worker may identify a type of work, or an area of interest for which the worker is willing to accept requests.

When the requests relate to searching for information, for example, as discussed in U.S. patent application Ser. No. 11/336,928, the server 26 communicates with information sources 25 via network 24a to obtain data in relation to goals specified by human workers and/or data pertaining to requests submitted from the requesters 27. The data from the information sources 25 may be text, image(s), multimedia content, link(s), or any other electronic data pertaining to the goals identified by the human workers or to requests submitted the requesters 27. Although networks 24a through 24c are illustrated in FIG. 1 as separate networks, the worker systems 22, the information sources 25 and the requesters 27 may connect to the server 26 using a single network. Further, any of the networks 24a through 24c may be a global public network of networks (the Internet) or consist in whole or in part of one or more private networks.

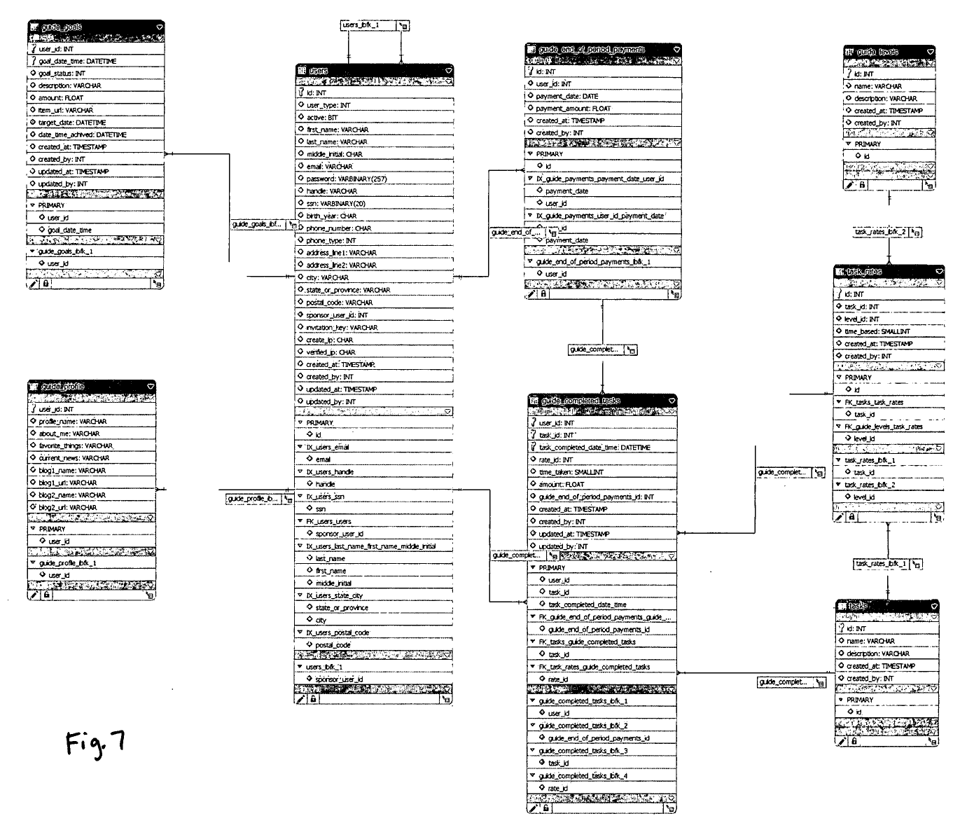

The database 30 maintains information pertaining to goal(s) identified by worker(s) in relation to work corresponding to the worker(s), types of work or task(s) performed by the worker(s), amount of work performed, amount of credit earned from work performed, amount of time for completion of performed work, amount of credit needed for achieving selected goal(s), credit earned based on work performed by other worker(s) including amount, remaining amount required for achieving goal(s), etc. Information of goal(s) identified by worker(s) and work(s) performed in relation to the goal(s) is explained in detail below with respect to FIG. 7.

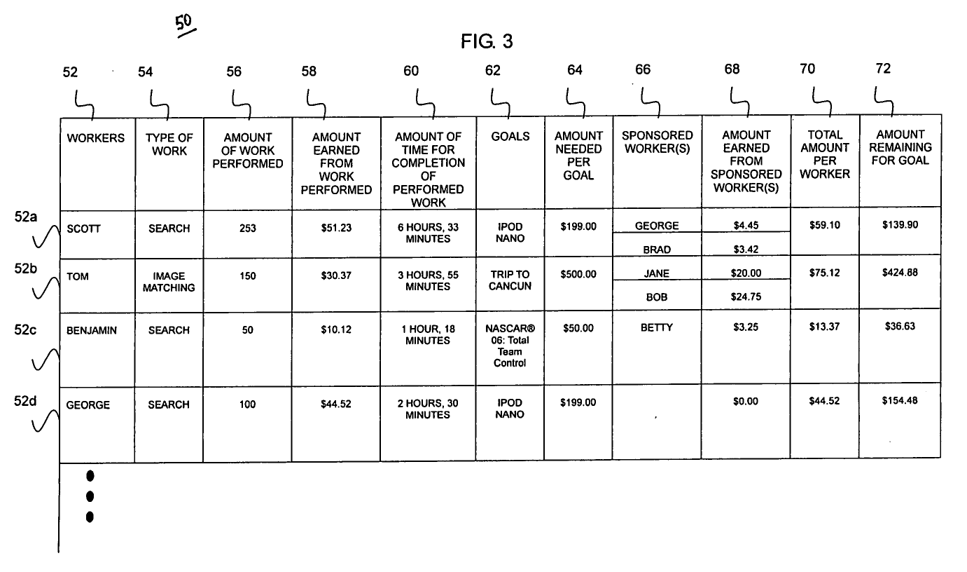

Information maintained in the database 30 is not limited to information of any particular type and may contain any data relevant to work carried out by human workers in association with goal(s) identified by the human workers. For example, information pertaining to completion, timeliness, quality, or any other factor affecting a request submitted to the system 20 and response thereto may be maintained in the database 30. In addition, the database 30 may maintain data related to goal(s) specified by worker(s) including a web page, link, image, audio recording, video, or any electronic containing information related to the goal(s) etc. The information maintained in the database 30 is explained in detail below with respect to FIG. 3.

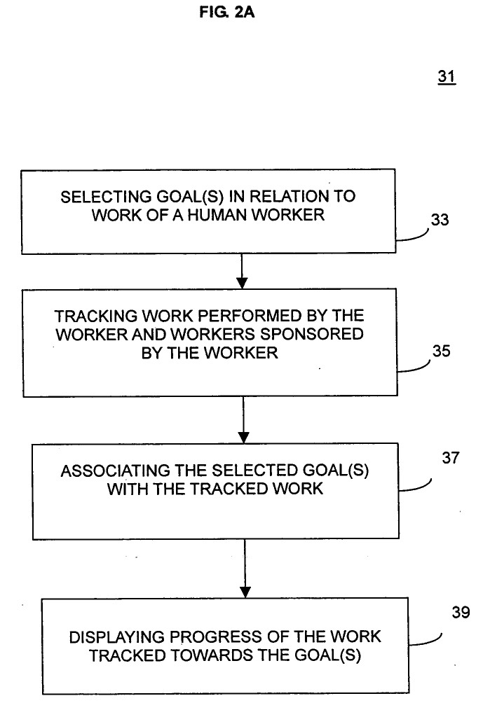

An exemplary process 40 for tracking goal(s) selected in relation to work of a worker is illustrated in FIG. 2. As shown in FIG. 2, process 40 begins by selecting 42 goal(s) in relation to work of a human worker. For example, a worker may identify a product (e.g., an iPod®), a destination such as Cancun, Mexico, etc., towards which the worker intends to perform work by handling requests submitted from requesters 27 (FIG. 1). However, a worker is not limited to selecting any type of goal or an objective towards which the worker attempts to advance and may designate one or more goals to be associated with any type of work the worker is registered to handle.

After selecting 42 the goal(s), process 40 continues by tracking 44 the work performed by the worker towards the selected goal(s). For example, credits (e.g., cash, points) rewarded to a worker for searches, for reviewing a predetermined number of photographs, for transcribing determined length of an audio recording, or whatever task is being performed are tracked. The tracking 44 includes but is not limited to monitoring the amount of work completed by the worker, the amount of time taken for completing the work, the amount of credit earned for the work including credit based on work performed by other worker(s), the type of work, etc. For example, responses accepted by requesters 27 (FIG. 1) as satisfying their requests may be tracked using randomly-generated IDs corresponding to the requesters and IDs permanently assigned to the workers to identify completion of the requested work.

Each time a unit of work is completed, a record may be inserted into the database 30 (FIG. 1) identifying the task or work completed, the rate being applied to the completion, the amount of time taken, the reward being credited (e.g., cash amount, points, etc.). For example, an ID may be assigned to a searcher registered to perform searches related to a particular subject matter in response to queries submitted by users (requesters) and upon completion of each search, the database 30 (FIG. 1) may maintain a record of the search, length of time for completion, rate of the search, amount credited to the searcher, etc.

The tracked work is associated 46 with the selected goal(s) of the worker. Using the same example discussed above, the iPod® identified as a goal by a worker may be associated with cash awarded to the worker for conducting searches in response to requests from the requesters 27 (FIG. 1). As another example, the iPod® may be associated with a number of searches completed by a worker over a given period of time where an iPod® is awarded to one who completes the most searches within the given period of time. The worker may also modify or update a current goal maintained in the database 30 (FIG. 1) for the worker and/or create a new goal to be associated with work performed by the worker.

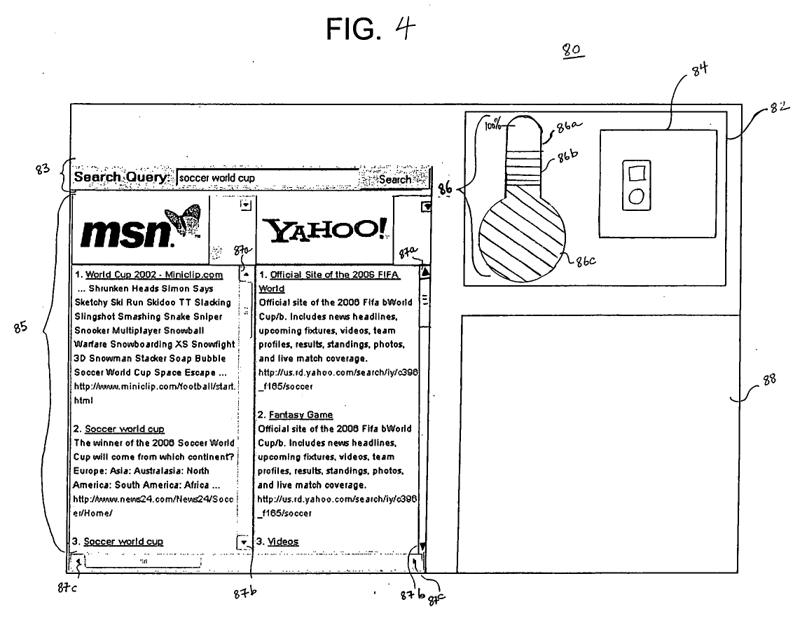

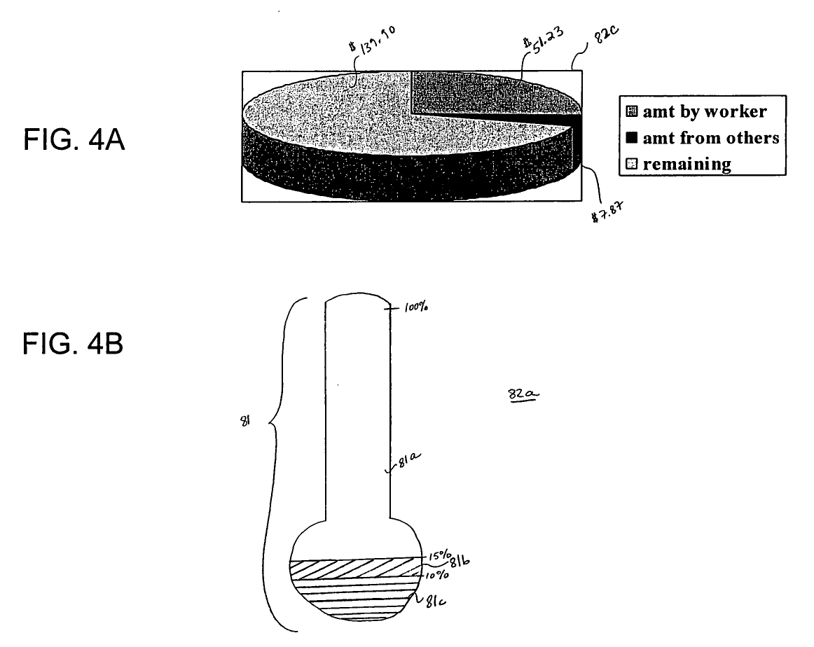

Subsequent to the associating 46, process 40 moves to displaying 48 the tracked work with respect to the goal(s) while work is being performed by the worker. For example, credit(s) rewarded for searches executed by a worker on behalf of requester(s) is tracked in association with obtaining the iPod® and information regarding the iPod®) is displayed to the worker while the worker continues to perform searches. An exemplary interface for displaying information pertaining to work associated with goal(s) of a worker is explained in detail below with respect to FIG. 4.

An exemplary process 31 for tracking work performed by a worker and workers sponsored by the worker with respect to goal(s) is illustrated in FIG. 2A. As shown in FIG. 2A, process 31 begins by selecting 33 goal(s) in relation to work of a human worker. As mentioned above, a worker may identify a particular destination, a product, a cash amount, etc., towards which the worker intends to perform work.

After selecting 33 the goal(s), process 31 continues by tracking 35 work performed by the worker and work performed by workers sponsored by the worker. The tracking 35 includes calculating credit (e.g., cash, points, etc) given to the worker for work performed by the worker and by other workers introduced to the system 20 (FIG. 1) by the worker to perform work. For example, a percentage of credit earned by other searchers for executing searches on behalf of requesters submitting queries is credited to the worker who sponsored the searchers. Similarly, a predetermined amount of points awarded to a sponsored worker who has completed a task is credited to the sponsoring worker.

The selected goal(s) is associated 37 with the tracked work. For example, if a worker identifies a specific amount of cash as a goal towards which the worker performs work, cash earned by performing the work will be tracked with respect to the specific amount of cash. As mentioned above, the worker may also be eligible to be credited with rewards earned based on work of other workers sponsored by the worker.

After the associating 37, process 31 moves to displaying 39 the tracked work with respect to the goal(s) while work is being performed by the worker. For example, credit(s) rewarded for searches executed by a worker on behalf of requester(s) is tracked in association with obtaining the iPod® and information regarding the iPod® is displayed to the worker with the searches are being executed.

FIG. 3 illustrates table 50 containing information of work in association with goals identified by workers. The table 50 includes information of workers 52, type of work 54, amount of work performed 56, amount earned 58, amount of time for completion 60, goals 62, amount needed per goal 64, sponsored worker(s) 66 and amount earned from sponsored worker(s) 68. The information contained in table 50 further includes total amount earned per worker 70, amount remaining for goal 72 and may include other information pertinent to tracking work performed by worker(s) and displaying the tracked work in association with goals defined by the workers. While the table 50 illustrates information of work in association with goals defined by workers, the present invention is not limited to maintaining any particular information of work and goals of workers. For example, a total number of completed tasks or works, a total accumulated time, etc., may be maintained in the table 50.

The workers 52 including worker 52a through worker 52d are associated with a corresponding type of work 54 for which the workers 52 have registered. For example, the type of work 54 for which worker 52a has registered is indicated as a search while the table 50 indicates that worker 52b is registered to handle image matching based on requests from requesters.

As shown in FIG. 3, various types of information pertaining to workers 52 is maintained in the table 50. For example, worker 52a is registered to handle requests for searches from requesters 27 (FIG. 1), has completed 253 searches which took 6 hours and 33 minutes resulting in earnings of $51.23. The selected goal of the worker 52a is an iPod® Nano which costs $199. The table 50 identifies that George and Brad are sponsored workers introduced to the system 20 (FIG. 1) by worker 52a and have earned $4.45 and $3.42 that is credited to worker 52a, respectively. Accordingly, the total amount credited to worker 52a is $59.10 towards the goal of obtaining the iPod® Nano, with a remaining amount of $139.90 for obtaining the ipod®) Nano. While the table 50 is illustrated using monetary amounts credited to workers, as mentioned above, the present invention is not limited to any particular type of credit or reward. For example, workers may be credited with a number of points for each task or work completed by the workers and respective sponsored workers.

Accordingly, workers are able to view a graphical representation of the amount credited towards a specific goal. An exemplary embodiment of a graphical user interface (GUI) 80 for displaying information pertaining to work specific to a worker is illustrated in FIG. 4. As shown in FIG. 4, the GUI 80 includes graphical representation 82 displaying information pertaining to tracked work specific to a worker in association with goal(s) identified by the worker. The graphical representation 82 includes a progress indicator 86 indicating work data in relation to the worker including the worker's advances towards an intended outcome (i.e., goal) identified by the worker. For example, as discussed in FIGS. 2 and 2A, a worker may identify a product such as an iPod®), a particular destination, etc., towards which the worker desires to earn credits.

The graphical representation 82 may include a frame 84 for displaying information related to goal(s) defined by a worker and a gauge 86 indicating progress made towards the goal(s) of the worker. The frame 84 may display a thumbnail of a product identified as a goal, a 3D image of the product, a Flash® demo providing an interactive simulation of a destination selected as a goal, etc. In addition, the frame 84 may provide additional description of the goal(s) obtained from information source(s) 25 (FIG. 1). For example, when a worker has specified an iPod® as a goal towards which the worker is performing work, web page information from apple.com or a link to the web page may be provided using a pop-up window when a worker points to an image of the iPod®) displayed in the frame 84. The frame 84 may be implemented using a programming language such as JavaScript® in a web-based application implemented using Java Web Start. When the frame 84 is part of a desktop client application, the frame 84 may be implemented using a programming language such as Java utilizing 2-D and 3-D graphic libraries, or other similar programming languages. However, the present invention is not limited to any particular type of interface for providing information of the goal(s) identified by the worker, for example, descriptive text pertaining to a product which the worker has identified as a goal may be integrated with an image of the product instead of being displayed using a pop-up window.

The GUI 80 may allow a worker to provide data pertaining to a goal identified by the worker for displaying the data in the frame 84, or the data may be retrieved by the server 26 (FIG. 1) from the information sources 25 (FIG. 1) upon identification of the goal by the worker. For example, if a worker obtains an image of a vehicle from the Internet, the server 26 (FIG. 1) may store the Uniform Resource Locator (URL) of a web page containing the image and cursor location information of the image within the web page and retrieve the image for displaying in the frame 84. Further, additional information pertaining to the image such as price, model of a product, etc., may be retrieved from the web page and/or one or more of the information sources 25 (FIG. 1) and may be displayed via the GUI 80. The GUI 80 may be configured to automatically determine information (e.g., price) of the image identified by a worker from an HTML source, or using an Optical Character Recognition (OCR), or using a pop-up window requesting the worker to manually enter information (e.g., price, name, etc.) regarding the image. Further, the goal may be selected from a prescribed list of items from a catalog provided by the system 20 (FIG. 1). In such case, the selection may include a URL link for graphical representation of the goal, associated price, etc.

Information of goal(s) defined by a worker displayed via the frame 84 may be automatically coupled to data of one or more of the information sources 25 pertaining to the defined goal(s). For example, the frame 84 may be configured to be linked to a web site of the Apple® computer company, or any other source over the Internet containing information of an iPod® which a worker may have identified as a goal.

The progress indicator or gauge 86 preferably displays work progress with respect to the goal(s) specified by the worker and may include indicators identifying remaining work to be completed 86a for achieving the goal(s), credit earned by other worker(s) 86b on behalf of the worker and credit earned by the worker 86c himself or herself. For example, with respect to worker 52a (FIG. 3), the gauge 86 may display a graph representing $139.90 as the remaining amount for obtaining the iPod®, $7.87 as the amount earned from worker(s) sponsored into the system 20 (FIG. 1) by worker 52a and $51.23 as the current credit earned by the worker 52a.

The gauge 86 may indicate other work information pertaining to identified goal(s) of the worker, for example, points earned for work completed, remaining points needed to earn the iPod® and points awarded to the worker for introducing or sponsoring new worker(s) to the system 20 (FIG. 1). As another example, the gauge 86 may indicate hours worked, number of searches completed, remaining number of hours or searches required to reach a goal, hour(s) of work or number of searches credited to a worker for sponsored worker(s), etc. Although the gauge 86 in FIG. 4 is illustrated as a thermometer, the present invention is not limited to any particular representation for displaying progress of work towards goal(s) defined by a worker. For example, a worker is able to customize the gauge 86 for displaying work information towards goal(s) by selecting from various representations such as a pie chart, bar graphs, etc. The system 20 (FIG. 1) may also automatically select a particular type of representation, for example, based on a type of work for which the worker has registered for displaying progress of work performed towards goal(s) identified by the worker.

It is desirable to be able, when tracking work pertaining to work performed by a worker, for a sponsoring worker to sign up other workers. The sponsoring worker may receive credit based on compensation earned by the signed-up workers. For example, as shown in FIG. 4B, if Joe signs up 15 providers (workers), Joe might receive credit equal to 10% of the compensation earned by each of the sponsored providers. If each of the sponsored providers individually earned $100 (including Joe), then Joe makes $100 for the searching he performed himself plus he earns 10% of $100 for each provider sponsored (e.g., $150) which means that the total amount earned by Joe is $250. Accordingly, if Joe specified a $1,000 laptop computer as a goal towards which he is performing work, the gauge 81 may display 10% using indicator 81c (denoting the work Joe did himself, another 15% with the indicator 81b (denoting the work performed by Joe's network of sponsored providers) and 75% using indicator 81a identifying remaining amount of work necessary for attaining Joe's specified goal (purchasing the laptop computer).

As shown in FIG. 4, the GUI 80 includes information returned 85 from resources in response to work performed by a worker, for example, a search conducted using MSN.com® and Yahoo.com® to obtain data pertaining to a query entered in search query field 83. The worker may view contents of the information returned 85 using elements 87a through 87c by scrolling through the contents. The GUI 80 may include frame 88 displaying results indicating findings of a worker performing work in response to a request from requester(s) 27. For example, as the worker is obtaining results from the information returned 85 for responding to a search request of a requester, results contents may be displayed in the frame 88.

The graphical representation 82 corresponding to work performance of a worker may be displayed while the worker is performing work. For example, while the worker is conducting a search over the Internet at a request of a requester, or updating results previously provided to a requestor, etc., a thumbnail of an iPod® that may be identified as a goal by the worker including the gauge 86 may be displayed in the search browser or application window. The displayed graphical representation 82 may be embedded within a window which a worker is utilizing to perform work or may be provided in a pop-up window that overlays the window used for the work. Further, when credit earned by the worker 86c is selected, the worker may be presented with information of the work performed

As illustrated in FIG. 4A, graphical representation 82c corresponding to work performance of a worker may be displayed to the worker. As mentioned above, a worker is able to customize the graphical representation 82 shown in FIG. 4 for displaying work information towards goal(s) by selecting from various representations such as a pie chart, bar graphs, etc. As shown in FIG. 4A, the graphical representation 82c indicating work information of worker 52a (FIG. 3) indicates remaining amount to be earned $139.90, credit earned by other worker(s) $7.87 on behalf of the worker and credit earned by the worker $51.23.

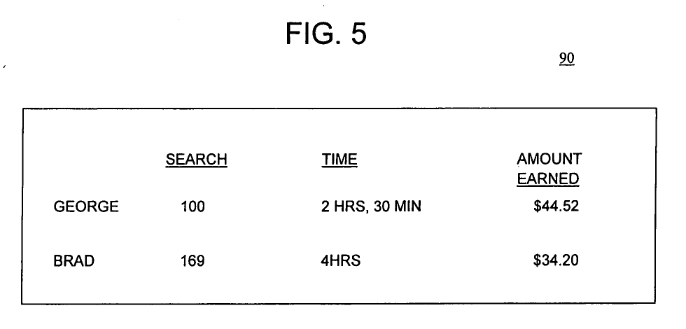

FIG. 5 illustrates a GUI 90 for displaying information related to work or task(s) performed by sponsored worker(s) of an individual worker. For example, when a worker selects indicator 86b of the gauge 86 illustrated in FIG. 4, GUI 90 may be provided to display information about credit earned from other worker(s) towards goal(s) of the individual worker as shown in FIG. 5. The GUI 90 displays information of work performed by a network of workers in relation to a worker. For example, if worker 52a (FIG. 3) introduced two workers (George and Brad) to the system 20, the worker 52a may receive a credit (e.g., 10% of credit earned) from work done by George and Brad. The GUI 90 may include information including the type of work completed by the sponsored worker(s), length of time for completing the work, a cash amount earned by the sponsoring worker for the work, etc. The information displayed via the GUI 90 may also include the rate at which the worker is earning, the number of minutes, a calculation of how much a sponsoring worker is making (i.e. 10%), a level of the worker (e.g., apprentice, pro, master, elite), a rank (e.g. 34/56 meaning 34^{th} ranked out of 56 guides on a particular keyword). In addition, the information may also indicate the keyword(s) of a search when the work relates to searches because the rate of pay may be different for each one. For example, elites get paid at $10 per hour level, master and pro get paid at $5 per hour level, and apprentice gets paid at $0 per hour level. The information may also indicate whether a worker is currently logged in or a time of last log in (i.e., logged in at XX:YY).

The GUI 90 may display information based on a comparison of other workers' performance level who are registered to perform similar type of work (e.g., workers registered to execute searches pertaining to a particular subject matter, etc.) as a particular worker and indicate credits calculated for the other workers including type of work completed, time for completing the work, amount of points earned, etc.

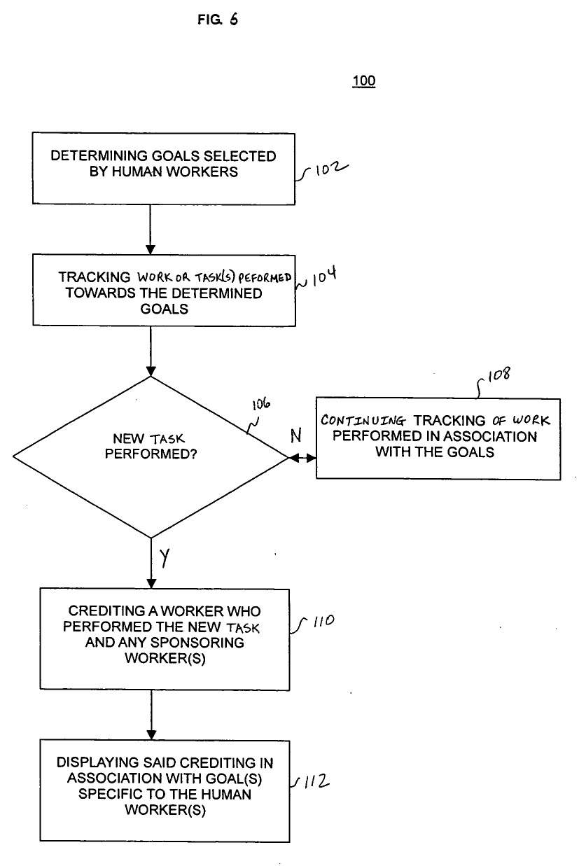

As discussed above, FIG. 2 illustrates process 40 for tracking goal(s) selected in relation to work of a worker. In cases where a worker is able to receive credit for sponsoring other worker(s) to the system 20 (FIG. 1), process 100 for tracking work or task(s) performed by the worker and by other worker(s) sponsored by the worker may be used as illustrated in FIG. 6. As shown in FIG. 6, process 100 begins by determining 102 goal(s) selected by human workers. For example, when a worker registers to the system 20 (FIG. 1), the worker may be prompted to set goal(s) towards which the worker wants to perform work such as a product of interest, a destination of choice, etc.

After determining 102, process 100 moves to tracking 104 work or task(s) performed towards the determined goals. For example, tracking credits issued for searches executed, photograph identification, transcription of audio recordings, image matching, etc., which are performed by worker(s) responsive to requests from requesters. The tracking 104 includes calculating cash, time, or any type of recognition earned by worker(s) for performing work.

Subsequent to tracking 104, process 100 moves to indicating whether there is a new task 106 that has been performed. Upon determining that no new task 106 has been performed, process 100 moves to continuing 108 tracking of work performed in association with the goals. On the other hand, when it is determined that there is new task 106 that has been performed, process 100 moves to crediting 110 a worker who performed the new task and any sponsoring worker(s). For example, a worker initiating registration of another worker to the system 20 (FIG. 1) may be credited when the other worker has performed a new task. An example of how a sponsoring worker is credited for work of a sponsored worker is explained above with respect to FIG. 3.

After crediting 110, process 100 displays 112 the credits in association with goal(s) specific to the human worker(s). For example, the GUI 80 shown in FIGS. 4 corresponding to each individual worker is displayed.

FIG. 7 illustrates tracking of work performed by guide(s). As shown in FIG. 7, data structures are provided for guide (or worker) goals, guide profile, users, guide end of period payments, guide completed tasks, guide levels, task rates and tasks. For example, each guide is associated with a guide profile data structure maintaining data related to ID, profile name, information about the guide, favorite things, current news, blog name, etc. and guide goal(s) including goal date/time, goal status, description, amount, item URL, target date, etc. The guide information is also associated with guide end period payments, tasks, completed tasks, guide level, task rates and tasks.

As illustrated with FIG. 5, tracking of the work includes determining sponsored guide(s) or worker(s) of a particular guide. As shown in FIG. 7, each guide profile is linked with user information having fields related to user ID, user type, first/last name, sponsor user ID, etc.

The requester-facing part of the system 27 preferably operates as a web application through a browser on a personal computer or as a voice application through an interactive voice response system. Typically, this would be a thin client, getting most or all of its data via the web page server, which can be a component of the server 26. The server might be one monolithic computer or it could be a distributed network of computers that slice up the processing of webpage serving, ad serving, query and results search, database accesses, etc. Alternatively, the requester-facing portion of the system may be a standalone application or a part of a standalone application (e.g. implemented through an SDK).

The worker-facing portion of the system 22 may also be implemented as a browser-based thin client that allows all of the significant processing, data flow, various information source connections, and data manipulation to occur at the server. However, preferably, because of scaling issues (i.e. handling very large volumes of requesters who each may require workers to be checking many sources per requester), it is preferable to implement the worker-facing portion of the system via a locally dynamic application that might run standalone or might run in the context of a browser. There are many examples of locally dynamic applications that do significant processing on the client side (in this case, worker side 22) while relying on data structures that exist on a server (in this case, the query server 26 which houses the database 30). Some examples of locally dynamic applications include Google® Earth (web-based mapping software), implemented using AJAX (Asynchronous Java combined with XML), and Base camp (web-based project management software), implemented using “Ruby on Rails”.

The worker- and requester-facing parts of the system may be implemented using these various mechanisms, but the heart of the system is in its database 30 (FIG. 1), which is preferably resident at the query server 26, which itself may be one or many computers working in harmony to implement various data structures. FIG. 7 shows the relationships of the data structure types. Primary data structure types are implemented for the requester, the guide, the request, the guide goals, the guide levels, guide end of period payments, guide completed tasks, and guide rates. Within these primary structures, there are pointing relationships to the other types. In this system, data structures are comprised of single instances and/or lists of these data types. For example, each requester is associated with a requester data structure, which has local data such as IP address, start time, personal information and demographics while also having pointers to the request that the requester has made, a list of advertisements that the requester has seen or is scheduled to see, the chat session between the requester and a worker (or workers), a link to the current worker, and a list of favorite workers that might be prioritized for this requester in the future.

Similarly, the guide goal structure has local data such as the guide ID, goal date and time as well as pointers to keywords associated with the goal, and a URL associated with the goal. Other relational connections are presented in FIG. 8 showing various data types of the database 30.

One example of the framework that may be used to implement the functionality includes having the worker-facing part of the system implemented as a WinForm application using .NET 2.0 using C# with embedded Flash 8.0 elements for capabilities such as the chat session portion of the interface. The database may be implemented using SQL Server 2000. The database may also be implemented using data structures such as pointers in a custom application, or using a database application such as Oracle, MySQL, Sybase, or the like. The requester-facing part of the system can be a Microsoft Internet Explorer running on a PC with the Flash 8 Plug-In. Alternatively, the worker-facing and/or the requester-facing part of the system may be implemented as Java script, as a Java application, as an ASP application, or the like, in conjunction with a browser such as Firefox, Opera, Safari, Mozilla, or the like.

The database 30 can include entries and a pointer-based structure as depicted in FIG. 7. This data structure or database 30 includes cross-linked entries for query, keyword, searcher, requester, query, advertisement, categories, and chat session. Within these structures include entries for logged-in status of worker (availability), rank (or weighting) of worker, rank (or weighting) of keyword, worker statistics such as number of searches, number of accepted (by requester) searches, requester identification (and/or IP address of requester), name, address, demographics about requesters and workers, search results, advertisements (game, video, text, audio, etc.), advertisement statistics, accounting information, anonymity flags for requester and worker, worker availability, query clarification and request (and/or chat session log), and an indication as to whether the worker is available for general searches, query follow-on, etc. The statistics for a worker can include the total number of searches, the number of successful searches, the average speed of the worker, the latency of the worker before starting and ending a search, the average number of results returned by the worker, the availability time of the worker, etc.

Accordingly, the disclosed system tracks work progress towards achieving a goal identified by an individual human worker and provides customized information including a breakdown of exactly how work to achieve the goal is being accomplished, amount of work hours, etc. Each individual worker is provided with information specific to identified goal(s) of the worker towards which credits accrue including thumbnail pictures of a destination in the Caribbean, a car, TV, iPod®, etc.

An individual worker may identify goal(s) by selecting tangible items from an online store, which may be part of the system 20 (FIG. 1) or, alternatively, might be obtained from information sources 25. Accordingly, each worker is provided with a corresponding display of progress information indicating advance(s) towards the identified goal(s), which may be presented to each worker while each is performing work with respect to the goal(s) identified (e.g. performing searches for requester(s) of a human-assisted search engine).

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the invention to the exact construction and operation illustrated and described for the disclosed embodiments, and accordingly all suitable modifications and equivalents may be resorted to, falling within the scope thereof. It will further be understood that the phrase “at least one of A, B and C” may be used herein as an alternative expression that means “one or more of A, B and C.”

What is claimed is:

1. A method, comprising:
associating a goal identified by a human worker with work performed by the human worker; and
tracking work performed by the human worker towards the goal identified.

2. The method according to claim 1, wherein said tracking includes determining work performed by workers sponsored by the worker.

3. The method according to claim 1, comprising:
displaying a customizable graphical representation of the tracked work including credits earned towards achieving the goal.

4. The method according to claim 3, wherein the customizable graphical representation is displayed while the worker is performing the work.

5. The method according to claim 1, comprising:
maintaining information of the work performed in relation to completion, timeliness and quality of the work and credits earned in accordance with the information.

6. The method according to claim 1, wherein the worker is a guide registered to execute searches responsive to requests submitted by users.

7. The method according to claim 6, wherein the goal identified is specific to the guide among multiple guides registered to execute the searches.

8. The method according to claim 7, wherein a search is performed by the guide with assistance from one of the multiple guides and said tracking of the goal is specific to the guide.

9. The method according to claim 6, wherein the goal is one of a cash amount, a product, or a point awarded to the guide based on each search executed by the guide.

10. The method according to claim 6, wherein the requests from the users are search queries and the work is directed to searches executed responsive to the search queries.

11. The method according to claim 6, wherein the goal identified is modifiable by the guide.

12. A method, comprising:
selecting a goal in relation to searches performed by a human guide, said human guide being registered to execute searches responsive to queries from users;
tracking credits earned for searches performed by the human guide towards the goal selected; and
displaying the tracked credits with respect to progress towards the goal.

13. The method according to claim 12, wherein said tracking includes determining searches performed by other human guides sponsored by and earning credits on behalf of the guide.

14. The method according to claim 13, wherein said displaying comprises:
indicating a remaining amount of searches to be completed for achieving the goal.

15. The method according to claim 13, wherein a predetermined percentage of credits earned by the guides sponsored is credited to the guide.

16. The method according to claim 12, wherein said displaying includes providing a web page, a link, an image, an audio recording, or a video related to the goal.

17. The method according to claim 12, wherein the goal is selected from a prescribed list of items based on a type of search for which the guide has registered.

18. A computer-readable medium having a program stored therein to cause a computer to execute operations, said operation comprising:
associating a goal identified by a human worker with work performed by the human worker; and
tracking work performed by the human worker towards the goal.

19. The computer-readable medium according to claim 18, comprising:
determining a type of work performed by the worker and calculating credits earned for the type of work toward the goal.

20. A system, comprising:
a requester device requesting performance of a unit of work;
a worker device using which a worker performs the work and identifies a goal to be achieved by performing the work; and
a database storing information of the work in association with the identified goal specific to the worker including progress made towards the goal, where the worker device displays said progress towards the goal.

21. The system according to claim 20, wherein descriptive data of the goal is obtained from an information source and displayed via the worker device.

22. The system according to claim 21, wherein the descriptive data of the goal is one of a web page, a link, an image, an audio recording, or a video containing information related to the goal.

23. An interface, comprising:
an input control for indicating a goal to be achieved by a guide registered to perform searches responsive to search queries; and
a progress indicator for displaying progress achieved by searches performed by the guide and other guides towards achieving the goal while the guide is performing searches.

24. A computer readable storage controlling a data structure comprising guide information; and
guide goal information provided using a computer, including:
guide profile identifiers;
task identifiers;
task rate identifiers;
sponsored searcher identifiers; and
guide level identifiers.

25. A system for tracking work of human workers, comprising:
at least one worker system transmitting goals selected by human workers in relation to searches performed by the workers and providing a customizable interactive display of the goals on a single display while the search is performed, said goals identifying one of a cash amount or a product made available at a URL specified by the workers and said interactive display providing a web page, a link, an image, an audio recording, or a video related to the goal;
a storage unit storing information of the workers in association with respective said goals selected by the workers; and
a server individually tracking searches performed by a worker towards a goal identified by the worker, where said tracking includes determining completion, quality, timeliness and quantity pertaining to the searches including in relation to searches performed by other workers, indicating progress towards the goal including a percentage of credit earned for searches performed by the worker and other workers sponsored by the worker.
